(19) United States
(12) Patent Application Publication
(10) Pub. No.: US 2024/0289004 A1
(43) Pub. Date: Aug. 29, 2024

(54) METHOD OF CONTROLLING COMPONENT, APPARATUS, ELECTRONIC DEVICE, AND STORAGE MEDIUM

(71) Applicant: Beijing Zitiao Network Technology Co., Ltd., Beijing (CN)

(72) Inventor: Ze ZHANG, Beijing (CN)

(21) Appl. No.: 18/569,983

(22) PCT Filed: Aug. 19, 2022
(86) PCT No.: PCT/CN2022/113547

§ 371 Date: Dec. 13, 2023

(30) Foreign Application Priority Data
Oct. 28, 2021 (CN) 202111265330.X

(51) Int. Cl. G06F 3/04845; G06F 3/04842; G06F 3/0486; G06F 3/0488; G06F 3/14

(52) U.S. Cl. CPC G06F 3/04845; G06F 3/04842; G06F 3/0486; G06F 3/0488; G06F 3/1407

(57) ABSTRACT

The present disclosure provides a method of controlling a component, an apparatus, an electronic device, and a storage medium, and the method includes: displaying an editing interface, in which the editing interface includes a component library region and a canvas region, the component library region includes a plurality of component identifiers for canvas editing, each component identifier is used to indicate one component, and the canvas region is used to display an edited component; and controlling a component copy to move following an input, in response to the input on a target component identifier selected in the component library region; the target component identifier is used to indicate a target component, and display content of the component copy is identical to display content of the target component.

### CROSS-REFERENCE TO RELATED APPLICATION

The present application claims the priority to Chinese Patent Application No. 202111265330.X, filed on Oct. 28, 2021 and entitled “METHOD OF CONTROLLING COMPONENT, APPARATUS, ELECTRONIC DEVICE, AND STORAGE MEDIUM”, the disclosure of which is incorporated by reference herein in its entirety.

### TECHNICAL FIELD

The present disclosure relates to the technical field of software development, and in particular, to a method of controlling a component, an apparatus, an electronic device, and a storage medium.

### BACKGROUND

Rich and reasonable page (e.g., marketing page, search page, live page, etc.) design may help attract users' attention and encourage users to participate in online activities such as online shopping, online search, network live, etc.

A page design process requires a developer to add a required component to a canvas region in a page editing interface, to generate a desired page layout. However, the existing component addition solutions cannot meet users' needs and affect user experience.

### SUMMARY

The present disclosure provides a method of controlling a component, an apparatus, an electronic device, and a storage medium.

A first aspect of embodiments of the present disclosure provides a method of controlling a component, and the method includes: displaying an editing interface, in which the editing interface includes a component library region and a canvas region, the component library region includes a plurality of component identifiers for canvas editing, each component identifier is used to indicate one component, and the canvas region is used to display an edited component; and controlling a component copy to move following a drag input, in response to the drag input on a target component identifier selected in the component library region, in which the target component identifier is used to indicate a target component, and display content of the component copy is identical to display content of the target component.

Optionally, a display size of the component copy is identical to a display size of the target component.

Optionally, after controlling the component copy to move following the drag input, the method further includes: displaying the target component in a first region, in a case where an end position of the drag input is in the first region of the canvas region; and moving the target component identifier to a second region, in a case where the end position of the drag input is in the second region of the component library region.

Optionally, after controlling the component copy to move following the drag input, the method further includes displaying prompt information before the drag input ends, in a case where the component copy enters the first region; the prompt information is used to indicate that if the drag input ends at a current position, the target component is displayed in the current position.

Optionally, after displaying the target component in the first region, in the case where the end position of the drag input is in the first region of the canvas region, or after moving the target component identifier to the second region, the method further includes cancelling displaying the component copy.

Optionally, before controlling the component copy of the target component to move following the drag input, the method further includes displaying a loading identifier, and the loading identifier is used to indicate to generate the component copy according to the target component identifier.

Optionally, the target component is a container component, and in a case where the container component is a container component other than a sliding container component, a mode of adding a component into the container component is a single row addition mode.

Optionally, a longitudinal size of the container component is adaptively adjusted with longitudinal sizes of respective components in the container component.

A second aspect of the embodiments of the present disclosure provides an apparatus of controlling a component, and the apparatus includes a display module and a control module; the display module is configured to display an editing interface, the editing interface includes a component library region and a canvas region, the component library region includes a plurality of component identifiers for canvas editing, each component identifier is used to indicate one component, and the canvas region is used to display an edited component; the control module is configured to control a component copy to move following a drag input, in response to the drag input on a target component identifier selected in the component library region; and the target component identifier is used to indicate a target component, and display content of the component copy is identical to display content of the target component.

Optionally, a display size of the component copy is identical to a display size of the target component.

Optionally, the apparatus further includes a move module; after controlling the component copy to move following the drag input, the display module is further configured to display the target component in a first region, in a case where an end position of the drag input is in the first region of the canvas region; and after controlling the component copy to move following the drag input, the move module is configured to move the target component identifier to a second region, in a case where the end position of the drag input is in the second region of the component library region.

Optionally, after controlling the component copy to move following the drag input, the display module is further configured to display prompt information before the drag input ends, in a case where the component copy enters the first region; and the prompt information is used to indicate that if the drag input ends at a current position, the target component is displayed in the current position.

Optionally, after displaying the target component in the first region, in the case where the end position of the drag input is in the first region of the canvas region, or after moving the target component identifier to the second region, the display module is further configured to cancel displaying the component copy.

Optionally, before controlling the component copy of the target component to move following the drag input, the display module is further configured to display a loading identifier, and the loading identifier is used to indicate to generate the component copy according to the target component identifier.

Optionally, the target component is a container component, and in a case where the container component is a container component other than a sliding container component, a mode of adding a component into the container component is a single row addition mode.

Optionally, a longitudinal size of the container component is adaptively adjusted with longitudinal sizes of respective components in the container component.

A third aspect of the embodiments of the present disclosure provides an electronic device, the electronic device includes a processor, a memory, and a computer program stored in the memory and executable on the processor; and the computer program, when executed by the processor, implements the steps of the method of controlling a component according to the first aspect.

A fourth aspect of the embodiments of the present disclosure provides a computer readable storage medium, storing a computer program, and the computer program, when executed by a processor, implements the steps of the method of controlling a component according to the first aspect.

A fifth aspect of the embodiments of the present disclosure provides a computer program product, storing a computer program, and the computer program, when executed by a processor, causes the processor to execute the computer program to implements the steps of the method of controlling a component according to the first aspect.

A sixth aspect of the embodiments of the present disclosure provides a chip, the chip includes a processor and a communication interface, the communication interface is coupled with the processor, and the processor is configured to run program instructions to implement the steps of the method of controlling a component according to the first aspect.

### BRIEF DESCRIPTION OF DRAWINGS

The drawings herein are incorporated into and form a part of the specification, illustrate the embodiments consistent with the present disclosure, and are used in conjunction with the specification to explain the principles of the present disclosure.

In order to more clearly illustrate the technical solutions in the embodiments of the present disclosure or in prior art, the drawings to be used in the description of the embodiments or prior art will be briefly described below, and it will be obvious to those ordinarily skilled in the art that other drawings can be obtained on the basis of these drawings without inventive work.

FIG. 1 is a first schematic diagram of an interface of a method of controlling a component provided by the embodiments of the present disclosure;

FIG. 2 is a first schematic diagram of a flow of a method of controlling a component provided by the embodiments of the present disclosure;

FIG. 3 is a second schematic diagram of an interface of a method of controlling a component provided by the embodiments of the present disclosure;

FIG. 4 is a second schematic diagram of a flow of a method of controlling a component provided by the embodiments of the present disclosure;

FIG. 5 is a third schematic diagram of a flow of a method of controlling a component provided by the embodiments of the present disclosure;

FIG. 6 is a fourth schematic diagram of a flow of a method of controlling a component provided by the embodiments of the present disclosure;

FIG. 7 is a third schematic diagram of an interface of a method of controlling a component provided by the embodiments of the present disclosure;

FIG. 8 is a structural block diagram of an apparatus of controlling a component provided by the embodiments of the present disclosure; and

FIG. 9 is a structural block diagram of an electronic device provided by the embodiments of the present disclosure.

### DETAILED DESCRIPTION

In order to understand the above objects, features and advantages of the present disclosure more clearly, the solutions of the present disclosure will be further described below. It should be noted that, in case of no conflict, the features in one embodiment or in different embodiments can be combined.

Many specific details are set forth in the following description to fully understand the present disclosure, but the present disclosure can also be implemented in other ways different from those described here; obviously, the embodiments in the specification are a part but not all of the embodiments of the present disclosure.

The terms “first”, “second”, etc. in the specification and claims of the present disclosure are used to distinguish similar objects and are not used to describe a particular order or sequence. It should be understood that the terms so used are interchangeable under appropriate cases, so that the embodiments of the present application may be implemented in an order other than those illustrated or described herein, and that the objects distinguished by the terms “first,” “second,” etc. are generally of one type and the number of the objects is not limited. For example, the number of a first object may be one or more than one. In addition, “and/or” in the specification and the claims indicates at least one of the connected objects, and the character “/” generally indicates an “or” relationship between the connected objects. The character “/” generally indicates that the related objects are in an “or” relationship.

The method of controlling a component provided by the embodiments of the present disclosure may be applied to various page editing scenarios, for example, scenarios of editing pages such as marketing pages, search pages, live pages, application pages (e.g., chat application pages, shopping application pages), etc., and the method includes: displaying an editing interface, in which the editing interface includes a component library region and a canvas region; and controlling a component copy to move following a drag input, in response to the drag input on a target component identifier selected in the component library region; the target component identifier is used to indicate a target component, and display content of the component copy is identical to a display content of the target component. In the solution, during the process of dragging the component through the drag input, the component copy whose display content is identical to the component is controlled to move following the drag input, that is, during the dragging process, a user may visually see an actual rendering effect, composition and structure, etc. of the component indicated by the operated component identifier, so that the actual rendering effect, the style, the composition and the structure, etc. of the component indicated by the component identifier may be determined without actually adding the component to the canvas region, which thus, may provide the user with more display modes of the component, may assist operations of the user, improve operation efficiency, and enhance user experience.

First, FIG. 1 is a schematic diagram of an interface of a method of controlling a component shown by the embodiments of the present disclosure. FIG. 1 shows a page editing interface 100, and the page editing interface 100 at least includes a component library region 110 and a canvas region 120. For example, the component library region 110 includes a plurality of component identifiers (or icons) for canvas editing, and the plurality of component identifiers may be divided into, but not limited to, a basic category, a container category, a tab category, a task category, an audio/video category, etc. according to types of components indicated.

The electronic device according to the embodiments of the present disclosure may be a mobile electronic device or a non-mobile electronic device. The mobile electronic device may be a mobile phone, a tablet computer, a laptop computer, a palmtop computer, a vehicle-mounted electronic device, a wearable device, an Ultra-Mobile Personal Computer (UMPC), a netbook, or a Personal Digital Assistant (PDA), etc.; the non-mobile electronic device may be a Personal Computer (PC), a Television (TV), a teller machine, or a self-service machine, which will not be specifically limited in the embodiments of the present disclosure.

An execution subject of the method of controlling a component provided by the embodiments of the present disclosure may be the above-mentioned electronic device (including mobile electronic devices and non-mobile electronic devices), or may also be a functional module and/or a functional entity in the electronic device that can implement the method of controlling a component, which may be specifically determined according to actual usage needs, and will not be limited in the embodiments of the present disclosure.

Hereinafter, the method of controlling a component provided by the embodiments of the present disclosure will be illustrated in detail through specific embodiments and application scenarios thereof, in conjunction with the drawings.

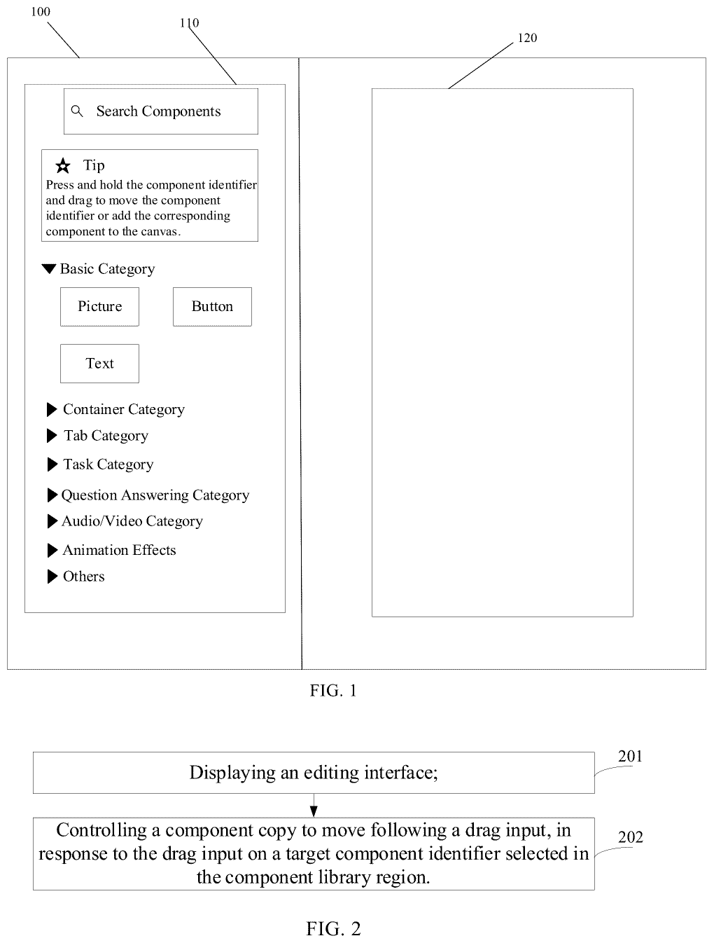

As shown in FIG. 2, the embodiments of the present disclosure provide a method of controlling a component. Hereinafter, the method of controlling a component provided by the embodiments of the present disclosure will be exemplarily illustrated by taking the execution subject as an electronic device. The method may include step 201 to step 202 below.

201: displaying an editing interface.

Specifically, the editing interface may be displayed for the electronic device. In the embodiments of the present disclosure, the editing interface may be a page editor interface.

For example, the editing interface includes a component library region and a canvas region; the component library region includes a plurality of component identifiers for canvas editing, each component identifier is used to indicate one component, and the canvas region is used to display an edited component.

202: controlling a component copy to move following a drag input, in response to the drag input on a target component identifier selected in the component library region.

Specifically, the above-mentioned step 202 may be that in response to the drag input on the target component identifier selected in the component library region, the electronic device controls the component copy to move following the drag input, based on a move parameter of the drag input.

For example, the target component identifier is used to indicate a target component, and display content of the component copy is identical to display content of the target component.

For example, the plurality of component identifiers displayed in the component library region may be understood as a directory of a plurality of component in a component library, and which component identifier the user selects corresponds to the component indicated by which component identifier is selected.

For example, the display content of the component copy may include style, composition, structure, and actual rendering effect, etc. of the component copy; if the display content of the component copy is identical to the display content of the target component, then the user may visually know style, composition, structure, and actual rendering effect, etc. of the component through the component copy, which may assist the user in selecting a position of the component.

In the embodiments of the present disclosure, the component copy may or may not have function of the component, which will not be limited in the embodiments of the present disclosure.

For example, the drag input refers to an input of selecting a target object, dragging the target object to a target region (position) then dropping, and displaying the dropped target object in the target region (position). The move parameter of the drag input refers to a real-time move position (coordinates) of the drag input during the implementation process of the drag input. It may be understood that based on the move parameter of the drag input, the component copy moves following the drag input, that is, the component copy moves following from an initial position of the drag input to an end position of the drag input all the way. For example, the initial position, for example, a position where the target component identifier is located in the component library region, corresponds to a drag start position; and the end position, any target exhibition position in the canvas region, corresponds to a drag end position. That is, during the drag input process, a real-time position of the drag input is just a real-time position corresponding to the component copy.

Exemplarily, if the user implements the drag input through a mouse, the component copy moving following the drag input may be understood as the component copy adsorbing onto a cursor and moving together with the cursor. If the user implements the drag input by touching a screen with his/her finger, the component copy moving following the drag input may be understood as the component copy adsorbing onto the finger and moving together with the finger.

The cursor, also referred to as a mouse pointer, is used to identify a mouse position on a graphical interface. The cursor may have different shapes, for example, arrow type, small hand type, etc.

The embodiments of the present disclosure provide a method of controlling a component, and the method includes: displaying an editing interface, in which the editing interface includes a component library region and a canvas region; and controlling a component copy to move following a drag input, in response to the drag input on a target component identifier selected in the component library region; the target component identifier is used to indicate a target component, and display content of the component copy is identical to a display content of the target component. In the solution, during the process of dragging the component through the drag input, the component copy whose display content is identical to the component is controlled to move following the drag input, that is, during the dragging process, a user may visually see an actual rendering effect, composition and structure, etc. of the component indicated by the operated component identifier, so that the actual rendering effect, the composition and the structure, etc. of the component indicated by the component identifier may be determined without actually adding the component to the canvas region, which thus, may provide the user with more display modes of the component, may assist operations of the user, and improve operation efficiency.

In some embodiments, the display size of the component copy is identical to the display size of the target component.

In the embodiments of the present disclosure, the display size of the component copy is identical to the display size of the target component, which may visually reflect the size of the component, thereby exhibiting a more visualized display effect of the component.

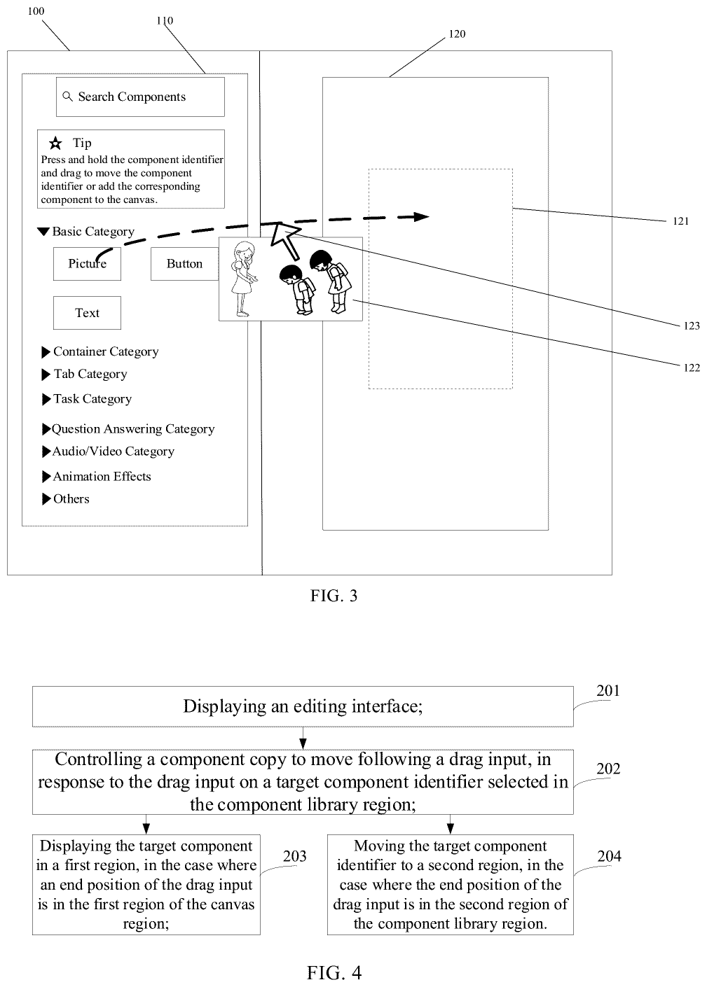

Exemplarily, as shown in FIG. 3, during the process of the user selecting a picture identifier and dragging the picture identifier onto a container 121 in the canvas region, the component copy 122 corresponding to a picture component indicated by the picture identifier moves together with a mouse 123.

In some embodiments, in conjunction with FIG. 2 and as shown in FIG. 4, after the above-mentioned step 202, the method of controlling a component provided by the embodiments of the present disclosure may further include step 203 or step 204.

203: displaying the target component in a first region, in the case where an end position of the drag input is in the first region of the canvas region.

Specifically, in the case where the end position of the drag input is in the first region of the canvas region, the electronic device displays the target component in the first region.

It may be understood that in the case where the user drags the component identifier to a certain container (the above-mentioned first region) in the canvas region, the electronic device displays the target component in the container of the canvas region. In this case, the target component is added to the container of the canvas region.

In some embodiments, the target component displayed in the first region may be a component copy (in which case the flow may be saved without a subsequent process of generating the target component and cancelling displaying the component copy), or may not be a component copy, which will not be limited in the embodiments of the present disclosure. In the case where the target component displayed in the first region is not a component copy, displaying the component copy may be cancelled after step 203. It should be noted that in the following description of the embodiments of the present disclosure, the target component displayed in the first region is not a component copy.

204: moving the target component identifier to a second region, in the case where the end position of the drag input is in the second region of the component library region.

Specifically, in the case where the end position of the drag input is in the second region of the component library region, the electronic device moves the target component identifier to the second region.

It may be understood that in the case where the user drags the component identifier to other region (the above-mentioned second region) in the component library region, the electronic device displays the target component in the canvas region. In this case, the electronic device adjusts the position of the target component identifier in the component library region.

In the embodiments of the present disclosure, during both processes of adding the component in the canvas region or adjusting the position of the component identifier in the component library region, the electronic device may control the component copy to move following the drag input, so that rendering effect of the component (style, shape, composition, structure, etc. of the component) indicated by the component identifier may be more visually exhibited.

In some embodiments, after adding the target component in the canvas region or adjusting the position of the target component identifier in the component library region, the component copy (the component copy corresponding to the target component) may be deleted timely, or all component copies (which may further include component copies of other components) may be deleted at a preset time, or the component copy may not be deleted, in case that the component copy is invoked again the next time the target component is added or the position of the target component identifier in the component library region is adjusted. For example, the preset time may be a time when displaying the editing interface is cancelled, or may also be a time when the edited page in the canvas region is saved, or may also be a time when the electronic device is shutdown, or may also be a fixed time (e.g., a fixed time in a day, a fixed time in a week, etc.).

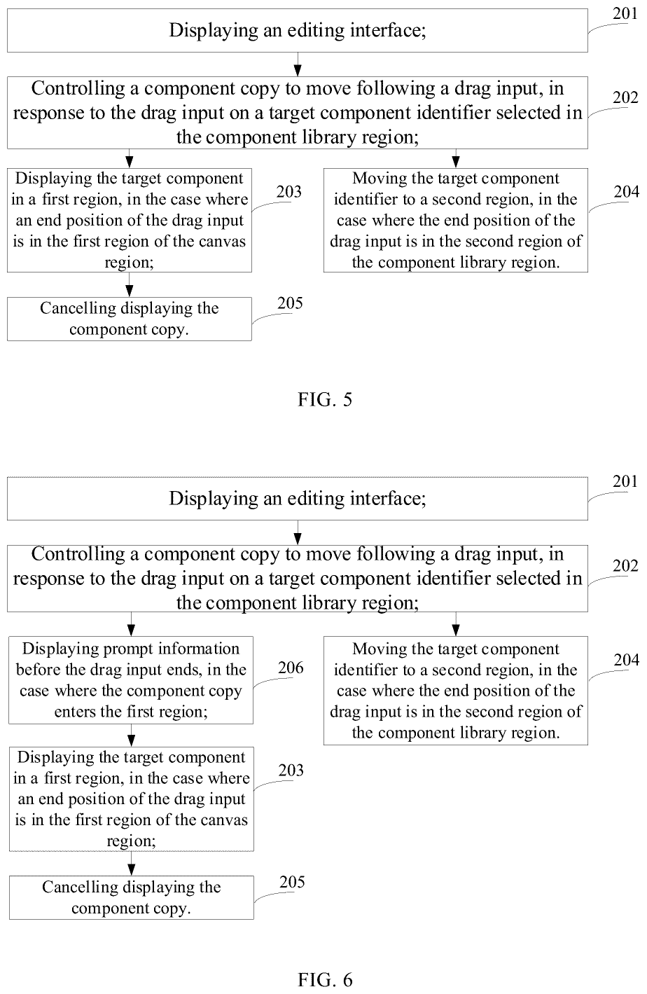

Exemplarily, in conjunction with FIG. 4, as shown in FIG. 5, after step 203 or step 204 as mentioned above, the method of controlling a component provided by the embodiments of the present disclosure may further include step 205 as mentioned below.

205: cancelling displaying the component copy.

Specifically, the electronic device cancels displaying the component copy.

In the embodiments of the present disclosure, the electronic device cancels displaying the component copy after adding the target component to the canvas region. The cancelling displaying the component copy may be deleting the component copy, so that storage space occupied by the component copy may be released timely; and cancelling displaying the component copy may also be hiding the component copy, so that the component copy may be reused the next time when it is necessary to add the target component or adjust the position of the target component identifier in the component library region, without regeneration, which improves the loading speed.

In some embodiments, in conjunction with FIG. 5, as shown in FIG. 6, after the above-mentioned step 202, the method of controlling a component provided by embodiments of the present disclosure may further include step 206.

206: displaying prompt information before the drag input ends, in the case where

the component copy enters the first region.

Specifically, before the drag input ends, the electronic device displays the prompt information in the case where the component copy enters the first region.

For example, the prompt information is used to indicate that if the drag input ends at the current position, the target component is displayed in the current position.

In some embodiments, the prompt information may include at least one of: text prompt information, pattern prompt information, and other forms of prompt information, which will not be limited in the embodiments of the present disclosure.

For example, the above-mentioned pattern prompt information is used to indicate the position of the target component after the current drag input is stopped; the pattern prompt information may be prompt information with a dashed box or prompt information with a thickened solid box; in addition, the pattern prompt information may have a flashing, specific color display effect, which will not be limited in the embodiments of the present disclosure.

In the embodiments of the present disclosure, by displaying the prompt information, the user may be assisted in making a decision about a drop point position of the target component, so that the target component is placed in a user desired position, which, thus, improves user operation efficiency and component editing efficiency.

In some embodiments of the present disclosure, before the drag input ends, in the case where the component copy enters the first region and the move speed of the drag input is less than a preset threshold, the prompt information is displayed.

In some embodiments, before the drag input ends, in the case where the component copy enters the first region and it is detected that the move speed of the drag input is less than the preset threshold, the electronic device displays the prompt information. The preset threshold may be determined according to actual usage needs, which will not be limited in the embodiments of the present disclosure. In this way, there is no need to constantly display the prompt information; prompting the user when the user has an intention to stop the drag input (decrease of the move speed of the drag input may indicate the intention to stop) may better assist the user in deciding the position of the target component in the first region, so as to improve operation efficiency.

In some embodiments, before the above-mentioned step 202, the method of controlling a component provided by the embodiments of the present disclosure may further include step 207 mentioned below.

207: display a loading identifier.

Specifically, the electronic device displays the loading identifier.

The loading identifier is used to indicate to generate the component copy according to the target component identifier.

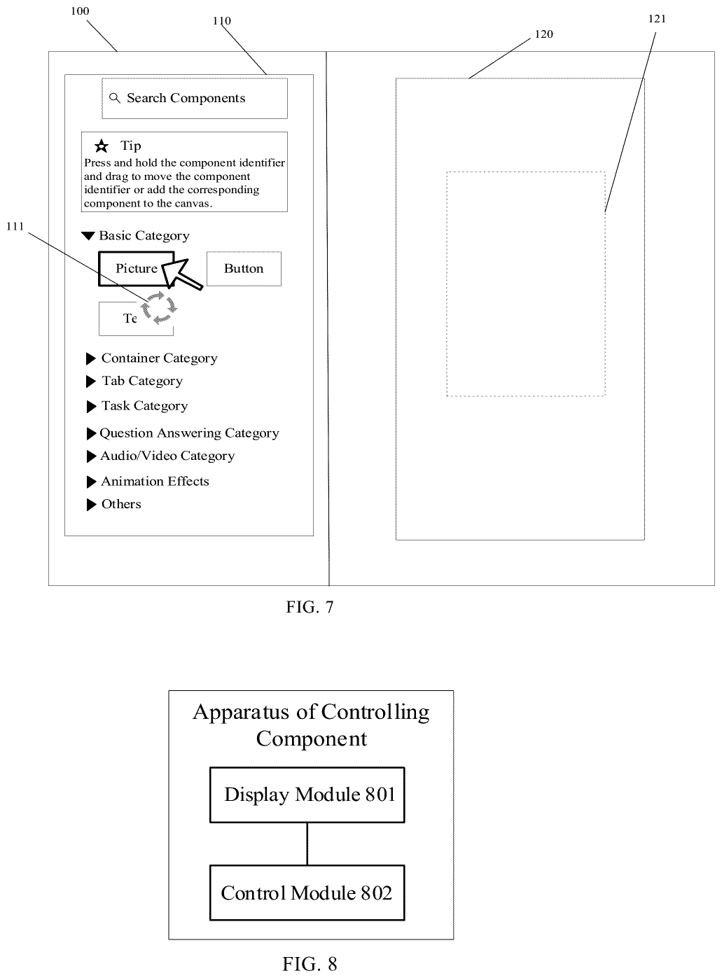

Exemplarily, as shown in FIG. 7, when the user selects a picture component identifier, the electronic device displays a loading identifier indicated by a markup “111”, to prompt the user that the component copy is currently being loaded.

For example, the loading identifier may be any preset identifier, which will not be limited in the embodiments of the present disclosure. For example, the loading identifier may be a loading identifier that displays a specific effect (e.g., a rotation effect).

In the embodiments of the present disclosure, by displaying the loading identifier, a dynamic loading process may be exhibited to the user, prompting the user that it is currently in a loading state and is about to generate a component copy.

In some embodiments, the target component is a container component, and in the case where the container component is a container component other than a sliding container component, the mode of adding a component into the container component is a single row addition mode.

It may be understood that the single row addition mode refers to that when adding a component to a container component, each component added occupies an exclusive row in the container component.

In the embodiments of the present disclosure, the single row addition mode may facilitate the user to control the position of each component, so that operation efficiency may be improved.

It should be noted that the container component may be briefly referred to as a container. In the page editing interface, when adding a component in the canvas region, it is usually necessary to first add a container-class component (the container component is a parent container), and then add a container component (i.e., a child container under the parent container) or other type of component (which may be referred to as a child component under the parent container) in the container component (the parent container).

The container component may include a carousel container, a navigation bar, a folding panel, a sliding container, and a pop-up window, etc., which will not be limited in the embodiments of the present disclosure. For example, the sliding mode of the sliding container, for example, a horizontal sliding mode (i.e. a horizontal sliding container) and a longitudinal sliding mode (i.e. a longitudinal sliding container) may be configured; the horizontal sliding container may allow horizontal addition of a child component, the component addition mode of the horizontal sliding container is a single column addition mode; and the longitudinal sliding container may allow longitudinal addition of a child component, and the component addition mode of the longitudinal sliding container is a single row addition mode.

In some embodiments, a longitudinal size of the container component is adaptively adjusted with longitudinal sizes of respective components in the container component.

It may be understood that the longitudinal size of the container component is determined by cumulative longitudinal sizes of the respective components in the container component. The longitudinal size of the container component changes with cumulative changes of the longitudinal sizes of the respective components, that is, the longitudinal size of the container component may be adaptively adjusted. The mode in which the longitudinal size of the container component may be adaptively adjusted may be referred to as a height (i.e. longitudinal size) adaption mode.

It may be understood that whether adding a component, deleting a component, or adjusting a component size in the container component, the longitudinal size of the container component changes correspondingly with the cumulative changes in the longitudinal sizes of the respective components therein.

In the embodiments of the present disclosure, the longitudinal size of the container component may be adaptively adjusted, which may reduce adjustment operations of the user to the size of the container component, so that operation efficiency may be improved.

In some embodiments, the container component may also be in a height fixation mode. In the height fixation mode, the longitudinal size of the container component may be adjusted through an operation by the user on the container component (e.g., inputting the longitudinal size in a size adjustment window or dragging a boundary of the container component to adjust the size, etc.). In the height fixation mode, the component in the container component that extends beyond the container component will be cropped.

Exemplarily, some implementations of the method of controlling a component provided by the present disclosure will be described below, but will not be limited to the implementations.

In a start stage of adding a component through drag, a component script (a loading identifier is displayed at this time) is dynamically loaded, and HTMLDivElement for mounting the component copy is created; after the component script is loaded completely (i.e. the component copy is generated), the component copy is rendered in the HTMLDivElement (i.e. the component copy is displayed); in a move stage of adding the component through drag, the HTMLDivElement and the rendered component copy therein will be taken as a mirror of the target component and move following the mouse; and in an end stage of adding the component through drag, the HTMLDivElement and the component copy are destroyed (i.e., the HTMLDivElement and the component copy are deleted). Because the mirror per se is an actual rendering result of the component, it may represent an actual size and style of the component, bringing the user a more visualized experience and assisting the user in making a decision about a drop point position, which improves operation efficiency of the user.

Exemplarily, the target component identifier is selected by a mouse in the component library to start mousedown; a div element is created, set to a fixed layout, and cached in a memory (i.e., a div for mounting a component copy is created); before returning the component script, a load state is first rendered in div (a loading identifier is displayed at this time) (i.e. the component script is loaded asynchronously and dynamically); after returning the component script, React.createPortal is used to render the component copy into div (i.e. the component copy is rendered into div). During a mousemove process, clientX (a clientX event attribute returns a horizontal coordinate of a mouse pointer relative to a browser page (or a client region) when the event is triggered, the client region refers to the current window), and clientY (a clientY event attribute returns a vertical coordinate of the mouse pointer relative to the browser page (or the client region) when the event is triggered) of the event are converted to left (left coordinate) and top (top coordinate) values of div in real time, so that div will move following the mouse. During mouseup, the component copy is deleted and div is destroyed.

It should be noted that div is a identifier element of a HyperText Markup Language (HTML) (an application under a standard universal markup language), and is an element used to provide structure and background for block-level content within an HTML document. Div is similar to a box used to mount a component copy, and in the page editing interface, div is displayed with a background of the component copy.

FIG. 8 is a structural block diagram of an apparatus of controlling a component shown in the embodiments of the present disclosure, as shown in FIG. 8, the apparatus includes a display module 801 and a control module 802; the display module 801 is configured to display an editing interface, and the editing interface includes a component library region and a canvas region; the component library region includes a plurality of component identifiers for canvas editing, each component identifier is used to indicate one component, and the canvas region is used to display an edited component; the control module 802 is configured to control a component copy to move following a drag input, in response to the drag input of a target component identifier selected in the component library region; and the target component identifier is used to indicate a target component, and display content of the component copy is identical to display content of the target component.

In some embodiments, the display size of the component copy is identical to the display size of the target component.

In some embodiments, the apparatus further includes a move module; the display module 801 is further configured to, after the control module 802 controls the component copy to move following the drag input, display the target component in a first region, in the case where an end position of the drag input is in the first region of the canvas region; and the move module is configured to, after the control module 802 controls the component copy to move following the drag input, move the target component identifier to a second region, in the case where the end position of the drag input is in the second region of the component library region.

In some embodiments, the display module 801 is further configured to, after the control module controls the component copy to move following the drag input, display prompt information before the drag input ends, in the case where the component copy enters the first region; and the prompt information is used to indicate that if the drag input ends at the current position, the target component is displayed in the current position.

In some embodiments, the display module 801 is further configured to, before the drag input ends, display prompt information in the case where the component copy enters the first region and the move speed of the drag input is less than a preset threshold.

In some embodiments, the display module 801 is further configured to, after displaying the target component in the first region, in the case where the end position of the drag input is in the first region of the canvas region, or after moving the target component identifier to the second region, cancel displaying the component copy.

In some embodiments, the display module 801 is further configured to, before controlling the component copy of the target component to move following the drag input, display a loading identifier, and the loading identifier is used to indicate to generate the component copy according to the target component identifier.

In some embodiments, the target component is a container component; and in the case where the container component is a container component other than a sliding container component, the mode of adding a component into the container component is a single row addition mode.

In some embodiments, a longitudinal size of the container component is adaptively adjusted with longitudinal sizes of respective components in the container component.

In the embodiments of the present disclosure, the apparatus of controlling a component may be the electronic device according to the above-mentioned method embodiments, or may also be a functional module and/or functional entity in the electronic device according to the above-mentioned method embodiments that can implement the functions of the above-mentioned apparatus embodiments, which will not be limited in the embodiments of the present disclosure.

In the embodiments of the present disclosure, the respective modules may implement the method of controlling a component provided by the above-mentioned method embodiments, and may achieve the same technical effect; and to avoid repetition, no details will be repeated here.

The embodiments of the present disclosure further provide an electronic device, and the electronic device may include a processor, a memory, and a computer program stored in the memory and may be executed on the processor; the computer program, when executed by the processor, may implement the respective processes of the method of controlling a component provided by the above-mentioned method embodiments, and may achieve the same technical effect; and to avoid repetition, no details will be repeated here.

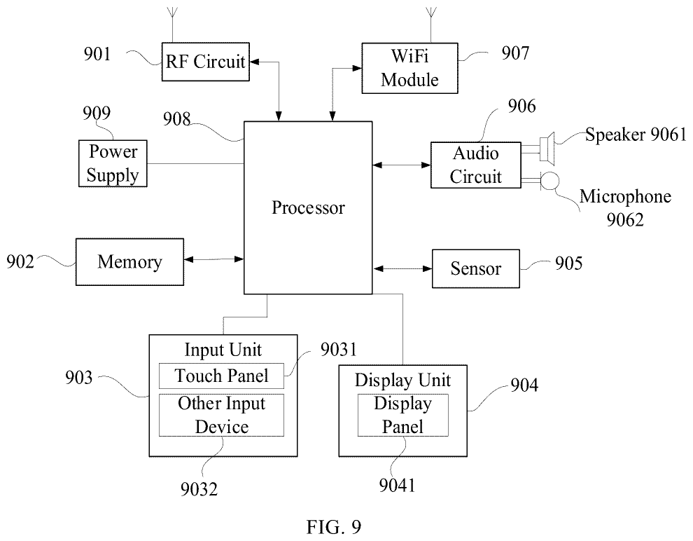

Exemplarily, FIG. 9 is a structural block diagram of hardware of an electronic device implementing the respective embodiments of the present disclosure; as shown in FIG. 9, the electronic device includes, but is not limited to components such as, a Radio Frequency (RF) circuit 901, a memory 902, an input unit 903, a display unit 904, a sensor 905, an audio circuit 906, a Wireless Fidelity (WiFi) module 907, a processor 908, and a power supply 909. For example, the radio frequency circuit 901 includes a receiver 9011 and a transmitter 9012. Those skilled in the art may understand that the structure of the electronic device shown in FIG. 9 does not constitute a limitation on the electronic device, and may include more or fewer components than shown, or combinations of certain components, or different component arrangements.

The RF circuit 901 may be configured to receive and send a signal during a process of receiving and transmitting information or phone communication, more particularly, receive downlink information from a base station and send the downlink information to the processor 908 for processing; and besides, send uplink data to the base station. Usually, the RF circuit 901 includes but is not limited to an antenna, at least one amplifier, a transceiver, a coupler, a Low Noise Amplifier (LNA), a duplexer, etc. In addition, the RF circuit 901 may also communicate with networks and other devices through wireless communication. The above-mentioned wireless communication may use any communication standard or protocol, including but not limited to Global System of Mobile Communication (GSM), General Packet Radio Service (GPRS), Code Division Multiple Access (CDMA), Wideband Code Division Multiple Access (WCDMA), Long Term Evolution (LTE), Email, Short Messaging Service (SMS), etc.

The memory 902 may be configured to store software programs and modules, and the processor 908 executes various functional applications and data processing of the electronic device by running the software programs and modules stored in the memory 902. The memory 902 may mainly include a storage program region and a storage data region, and the storage program region may store an operating system, an application program required for at least one function (e.g., a sound playback function, an image playback function, etc.), etc.; and the storage data region may store data (e.g., audio data, phone books, etc.) created according to use of the electronic device, etc. In addition, the memory 902 may include a high-speed random-access memory, and may also include a non-volatile memory, for example, at least one disk storage device, a flash device, or other volatile solid-state storage device.

The input unit 903 may be configured to receive input numerical or character information, and generate key signal inputs related to user settings and functional control of the electronic device. Specifically, the input unit 903 may include a touch panel 9031 and other input device 9032. The touch panel 9031, also referred to as a touch screen, may collect touch operations of a user on or in the vicinity thereof (e.g., operations of the user on the touch panel 9031 or near the touch panel 9031 using any suitable object or accessory such as a finger, a stylus, etc.), and drive a corresponding connection apparatus according to a preset program. In some embodiments, the touch panel 9031 may include two parts: a touch detecting apparatus and a touch controller. For example, the touch detecting apparatus detects a touch direction of the user, detects a signal brought by the touch operation, and transmits the signal to the touch controller; and the touch controller receives touch information from the touch detecting apparatus, converts the touch information into contact coordinates, then sends the contact coordinate to the processor 908, and is also capable of receiving commands sent from the processor 908 and executing the commands. In addition, the touch panel 9031 may be implemented by using various types, such as a resistive type, a capacitive type, an infrared type, and a surface acoustic wave type. In addition to the touch panel 9031, the input unit 903 may further include other input device 9032. Specifically, the other input device 9032 may include but is not limited to one or more of a physical keyboard, a function key (e.g., a volume control button, a switch button, etc.), a trackball, a mouse, a joystick, etc.

The display unit 904 may be configured to display information input by the user or information supplied to the user, as well as various menus of the electronic device. The display unit 904 may include a display panel 9041, and in some embodiments, the display panel 9041 may be configured in a form of a Liquid Crystal Display (LCD), an Organic Light-Emitting Diode (OLED), or the like. Further, the touch panel 9031 may cover the display panel 9041; when the touch panel 9031 detects a touch operation on or near it, a signal is transmitted to the processor 908 to determine a touch event, and the processor 908 subsequently provides a corresponding visual output on the display panel 9041 based on the touch event. In FIG. 9, although the touch panel 9031 and the display panel 9041 serve as two independent parts to implement input and output functions of the electronic device, yet in some embodiments, the touch panel 9031 and the display panel 9041 may be integrated to implement the input and output functions of the electronic device.

The electronic device may further include at least one sensor 905, for example, a light sensor, a motion sensor, and other sensors. Specifically, the light sensor may include an ambient light sensor and a proximity sensor, the ambient light sensor may adjust brightness of the display panel 9041 according to brightness of the ambient light, and the proximity sensor may exit the display panel 9041 and/or backlight when the electronic device is moved to the ear. As a type of the motion sensor, an accelerometer sensor may detect magnitudes of accelerations in various directions (usually three axes), may detect a magnitude and a direction of gravity at a standstill, and may be used in applications that recognize electronic device postures (e.g., horizontal-vertical screen switch, relevant games, magnetometer posture calibration), vibration recognition related functions (e.g., pedometers, tapping), etc.; as for other sensors such as a gyroscope, a geomagnetic sensor, a barometer, a hygrometer, a thermometer, an infrared sensor, etc. that may also be configured for the electronic device, no details will be repeated here. In the embodiments of the present disclosure, the electronic device may include an acceleration sensor, a depth sensor, or a distance sensor, etc.

The audio circuit 906, the speaker 9061, and the microphone 9062 may provide an audio interface between the user and the electronic device. The audio circuit 906 may convert received audio data into an electrical signal and transmit the electrical signal to the speaker 9061, and the speaker 9061 converts the electrical signal into a sound signal for output; on the other hand, the microphone 9062 converts the collected sound signal into an electrical signal, the audio circuit 906 receives the electrical signal and converts the electrical signal into audio data, and then output the audio data to the processor 908 for processing; the RF circuit 901 may send the audio data to, for example, another electronic device, or output the audio data to the memory 902 for further processing.

WiFi belongs to short range wireless transmission technology, and the electronic device may help the user send and receive emails, browse web pages, and access streaming media, etc. through the WiFi module 907, which provides the user with wireless broadband internet access. Although FIG. 9 shows the WiFi module 907, it may be understood that it is not a necessary component of the electronic device and may be omitted as needed within the scope without changing the essence of the present disclosure.

The processor 908 is a control center of the electronic device, connects the respective parts of the entire electronic device through various interfaces and circuits, and executes respective functions and processes data of the electronic device by running or executing software programs and/or modules stored in the memory 902, as well as invoking data stored in the memory 902, so as to perform overall monitoring of the electronic device. In some embodiments, the processor 908 may include one or more processing units; in some embodiments, the processor 908 may integrate an application processor and a modulation and demodulation processor, the application processor mainly processes an operating system, a user interface, and an application program, etc., while the modulation and demodulation processor mainly processes wireless communication. It may be understood that the above-mentioned modulation and demodulation processor may not be integrated into the processor 908.

The electronic device further includes a power supply 909 (e.g., a battery) that powers the respective components; in some embodiments, the power supply may be logically connected with the processor 908 through a power management system, so as to implement functions such as charging, discharging, and power consumption management through the power management system. Although not shown, the electronic device may further include a Bluetooth module, etc., and no details will be repeated here.

In the embodiments of the present disclosure, the display unit 904 is configured to display an editing interface, and the editing interface includes a component library region and a canvas region; the component library region includes a plurality of component identifiers for canvas editing, each component identifier is used to indicate one component, and the canvas region is used to display an edited component; the processor 908 is configured to control the component copy to move following a drag input, in response to the drag input of a target component identifier selected in the component library region; the target component identifier is used to indicate the target component, and the display content of the component copy is identical to the display content of the target component.

The embodiments of the present disclosure further provide a computer readable storage medium, the computer readable storage medium stores a computer program, and the computer program, when executed by a processor, implements the respective processes of the method of controlling a component provided by the above-mentioned method embodiments, and may achieve the same technical effect; and to avoid repetition, no details will be repeated here.

The embodiments of the present disclosure further provide a computer program product, the computer program product includes a computer program, and the computer program product, when running on a processor, causes the processor to execute the computer program to implement the respective processes of the method of controlling a component provided by the above-mentioned method embodiments, and may achieve the same technical effect; and to avoid repetition, no details will be repeated here.

In the embodiments of the present disclosure, the computer program includes a computer program or a computer instruction.

The embodiments of the present disclosure further provide a chip, the chip includes a processor and a communication interface, the communication interface is coupled with the processor, and the processor is configured to run programs or instructions to implement the respective processes of the method of controlling a component provided by the above-mentioned method embodiments, and may achieve the same technical effect; and to avoid repetition, no details will be repeated here.

It should be understood that the chip as mentioned in the embodiments of the present disclosure may also be referred to as a system level chip, a system chip, a chip system, or System on Chip, etc.

In some embodiments provided by the present disclosure, it should be understood that the disclosed system, apparatus, server, and method may be implemented in other modes. For example, the apparatus embodiments as described above are only schematic, for example, the division of the units may be logical functional division; in actual implementation, there may be other division modes, for example, a plurality of units or components may be combined or integrated into another system, or some features may be ignored or not executed. On the other hand, the coupling or direct coupling or communication connection displayed or discussed between each other may be indirect coupling or communication connection through some interfaces, apparatuses, or units, which may be in a form of electrical, mechanical or other forms.

The above-mentioned units illustrated as separate components may be, or may not be physically separated, and the components displayed as units may be, or may not be, physical units, that is, they may be at one place, or may also be distributed to a plurality of network units; and some or all of the units may be selected according to actual needs to achieve the purpose of the solutions of the present embodiment.

In addition, the respective functional units in the respective embodiments of the present disclosure may be integrated in one processing unit, or each unit may physically exist separately, or two or more units may be integrated in one unit. The above-mentioned integrated unit may be implemented in a form of hardware, or may also be implemented in a form of software functional unit.

In the case where the integrated unit is implemented in a form of software functional unit and sold or used as an independent product, the integrated unit may be stored in a computer readable storage medium. Based on such understanding, the technical solutions of the present disclosure, in essence, or the part that contributes to the prior art, or all or part of the technical solutions, may be embodied in a form of a software product; the computer software product is stored in a storage medium and includes several instructions so that a computer device (which may be a personal computer, a server, or a network device, etc.) to execute all or part of steps of the methods according to the respective embodiments of the present disclosure. The foregoing storage medium includes a USB flash disk, a removable hard disk, a Read-Only Memory (ROM), a Random-Access Memory (RAM), a magnetic disk or an optical disk, and various other media that can store program codes.

The foregoing embodiments are merely used to illustrate the technical solutions of the present disclosure, and not to limit the present disclosure; although the present disclosure is described in detail with reference to the foregoing embodiments, those of ordinary skill in the art should understand that they may still make modifications to the technical solutions recorded in the respective foregoing embodiments, or equivalent substitutions to some of the technical features in the technical solutions recorded in the respective foregoing embodiments; and these modifications or substitutions do not separate the essence of the corresponding technical solutions from the spirit and the scope of the technical solutions of the respective embodiments of the present disclosure.

1. A method of controlling a component, comprising:
displaying an editing interface, wherein the editing interface comprises a component library region and a canvas region, the component library region comprises a plurality of component identifiers for canvas editing, each component identifier is used to indicate one component, and the canvas region is used to display an edited component; and
controlling a component copy to move following an input, in response to the input on a target component identifier selected in the component library region,
wherein the target component identifier is used to indicate a target component, and display content of the component copy is identical to display content of the target component.

2. The method according to claim 1, wherein a display size of the component copy is identical to a display size of the target component.

3. The method according to claim 1, wherein after controlling the component copy to move following the input, the method further comprises:
displaying the target component in a first region, in a case where an end position of the input is in the first region of the canvas region; and
moving the target component identifier to a second region, in a case where the end position of the input is in the second region of the component library region.

4. The method according to claim 3, wherein after controlling the component copy to move following the input, the method further comprises:
displaying prompt information before the input ends, in a case where the component copy enters the first region;
the prompt information is used to indicate that if the input ends at a current position, the target component is displayed in the current position.

5. The method according to claim 4, wherein displaying prompt information before the input ends, in a case where the component copy enters the first region, comprises:
displaying the prompt information before the input ends, in a case where the component copy enters the first region and a move speed of the input is less than a preset threshold.

6. The method according to claim 3, wherein after displaying the target component in the first region, in the case where the end position of the input is in the first region of the canvas region, or after moving the target component identifier to the second region, the method further comprises:
cancelling displaying the component copy.

7. The method according to claim 1, wherein before controlling the component copy of the target component to move following the input, the method further comprises:
displaying a loading identifier, wherein the loading identifier is used to indicate to generate the component copy according to the target component identifier.

8. The method according to claim 1, wherein the target component is a container component, and in a case where the container component is a container component other than a sliding container component, a mode of adding a component into the container component is a single row addition mode.

9. The method according to claim 8, wherein a longitudinal size of the container component is adaptively adjusted with longitudinal sizes of respective components in the container component.

10. An apparatus of controlling a component, comprising a display module and a control module,
wherein the display module is configured to display an editing interface, the editing interface comprises a component library region and a canvas region, the component library region comprises a plurality of component identifiers for canvas editing, each component identifier is used to indicate one component, and the canvas region is used to display an edited component;
the control module is configured to control a component copy to move following an input, in response to the input on a target component identifier selected in the component library region; and
the target component identifier is used to indicate a target component, and display content of the component copy is identical to display content of the target component.

11. An electronic device, comprising a memory and a processor, wherein the memory is configured to store a computer program, and the processor is configured to, when invoking the computer program, execute the method of controlling a component according to claim 1.

12. A computer readable storage medium, storing a computer program, wherein the computer program, when executed by a processor, implements the method of controlling a component according to claim 1.

13. (canceled)

14. The apparatus of controlling a component according to claim 10, wherein a display size of the component copy is identical to a display size of the target component.

15. The apparatus of controlling a component according to claim 10, further comprising a move module,
wherein the display module is further configured to, after the control module controls the component copy to move following the input, display the target component in a first region, in a case where an end position of the input is in the first region of the canvas region; and
the move module is configured to, after the control module controls the component copy to move following the input, move the target component identifier to a second region, in a case where the end position of the input is in the second region of the component library region.

16. The apparatus of controlling a component according to claim 15, wherein the display module is further configured to, after the control module controls the component copy to move following the input, display prompt information before the input ends, in a case where the component copy enters the first region; and
the prompt information is used to indicate that if the input ends at a current position, the target component is displayed in the current position.

17. The apparatus of controlling a component according to claim 16, wherein the display module is further configured to display the prompt information before the input ends, in a case where the component copy enters the first region and a move speed of the input is less than a preset threshold.

18. The apparatus of controlling a component according to claim 15, wherein the display module is further configured to, after displaying the target component in the first region in the case where the end position of the input is in the first region of the canvas region, or after moving the target component identifier to the second region, cancel displaying the component copy.

19. The apparatus of controlling a component according to claim 10, wherein the display module is further configured to, before controlling the component copy of the target component to move following the input, display a loading identifier; and
the loading identifier is used to indicate to generate the component copy according to the target component identifier.

20. The apparatus of controlling a component according to claim 10, wherein the target component is a container component, and in a case where the container component is a container component other than a sliding container component, a mode of adding a component into the container component is a single row addition mode.

21. The apparatus of controlling a component according to claim 20, wherein a longitudinal size of the container component is adaptively adjusted with longitudinal sizes of respective components in the container component.
